(19) United States
(12) Patent Application Publication
(10) Pub. No.: US 2006/0001227 A1
(43) Pub. Date: Jan. 5, 2006

(54) Scooter

(76) Inventor: Jae Hyun Hong, Santa Fe Springs, CA (US)

Correspondence Address: PARK & SUTTON LLP, 3255 WILSHIRE BLVD, SUITE 1110, LOS ANGELES, CA, 90010, US

(21) Appl. No.: 10/885,534

(22) Filed: Jul. 2, 2004

(51) Int. Cl. B62M 1/00

(52) U.S. Cl. 280/87.041

(57) ABSTRACT

A scooter including a footboard, a plurality of wheels rotatably attached to the footboard, an elongated rod attached to the footboard, a handle attached to the enlongated rod and a decorative portion is provided. The footboard includes a front end and a rear end. The elongated rod is attached near or at the front end. The decorative portion includes a front decorative portion that is attached near or at the front end. The front decorative portion has a shape of a shell having a front cavity. The front cavity substantially encloses the front end of the footboard. The front decorative portion simulates a vehicle or an animal. The decorative portion may also include a rear decorative portion near the rear end, side decorative potions on the sides of the footboard, and a handle decorative portion.

### BACKGROUND OF THE INVENTION

The present invention relates to a scooter. More particularly, this invention relates to a scooter with a decorative head and a handle panel that simulate machines or animals, etc.

There are many scooters by prior art. A scooter generally provides a function of funny and easy riding for a user. Since using a scooter requires little skill, a scooter is widely used for children's entertainment. While scooters by prior art generally provided operability, safety and convenience etc. that are essentially required for children's toys, no scooters by prior art provided aesthetic appearance that can simulate feelings related to common objects that are interesting to the children, such as cars or animals.

A scooter having aesthetic function that can simulate common objects so that it can induce children's great interest has long been in need.

### SUMMARY OF THE INVENTION

The present invention contrives to solve the disadvantages of the prior art.

An objective of the invention is to provide a scooter that has an aesthetic appearance.

Another objective of the invention is to provide a scooter having appearance that simulates feelings of objects that are popular among children.

Still another objective of the invention is to provide a scooter having appearance having decorative parts that vary in position, size and design.

To achieve the above objectives, the present invention provides a scooter that includes a footboard, a plurality of wheels rotatably attached to the footboard, an elongated rod attached to the footboard, a handle attached to the enlongated rod and a decorative portion. The footboard includes a front end and a rear end. The elongated rod is attached near or at the front end. The decorative portion includes affront decorative portion that is attached near or at the front end.

The front decorative portion has a shape of a shell having a front cavity. The front cavity substantially encloses the front end of the footboard.

The front decorative portion simulates a front portion of a vehicle, and the wheels near the front end of the footboard simulate wheels of a vehicle.

Specifically, the front decorative portion simulates a front portion of a fire engine or a police car. The elongated rod passes through the roof of the fire engine or the police car. The roof includes a portion simulating an emergency light.

The decorative portion further includes a handle decorative portion that is attached to the handle. The handle decorative portion includes one or more lamps that simulate lamps of the vehicle.

Alternatively, the front decorative portion simulates a head and/or body of an animal.

The front decorative portion may be integrated with the footboard.

The decorative portion further includes a rear decorative portion that is attached at the rear end of the footboard.

The rear decorative portion may be integrated with the footboard.

The rear decorative portion has a shape of a shell having a rear cavity. The rear cavity substantially encloses the rear end of the footboard.

The rear decorative portion simulates a rear portion of a vehicle, and the wheels near the rear end of the footboard simulate wheels of a vehicle.

Alternatively, the rear decorative portion simulates a body of an animal.

The decorative portion further includes one or more side decorative portions that are attached to the sides of the footboard.

The side decorative portions may be integrated with the footboard.

The advantages of the present invention are: (1) a scooter having aesthetic appearance in addition to the function of handy riding means is provided; (2) the scooter simulates popular objects among children and thus induces interest and fun to children; (3) the scooter is safer since the flexible decorative portions provide a buffer and absorb impact energy.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a scooter of the present invention, which simulates a fire engine;

FIG. 2 is a perspective view of another scooter of the present invention, which simulates a police car;

FIG. 3 is an elevation view of the scooter;

FIG. 4 is a cross-sectional view taken along the line 4-4 in FIG. 3;

FIG. 5 is a perspective view of still another scooter of the present invention, which simulates an animal;

FIG. 6 is an elevation view of the scooter; and

FIG. 7 is a cross-sectional view taken along the line 7-7 in FIG. 6.

### DETAILED DESCRIPTION OF THE INVENTION

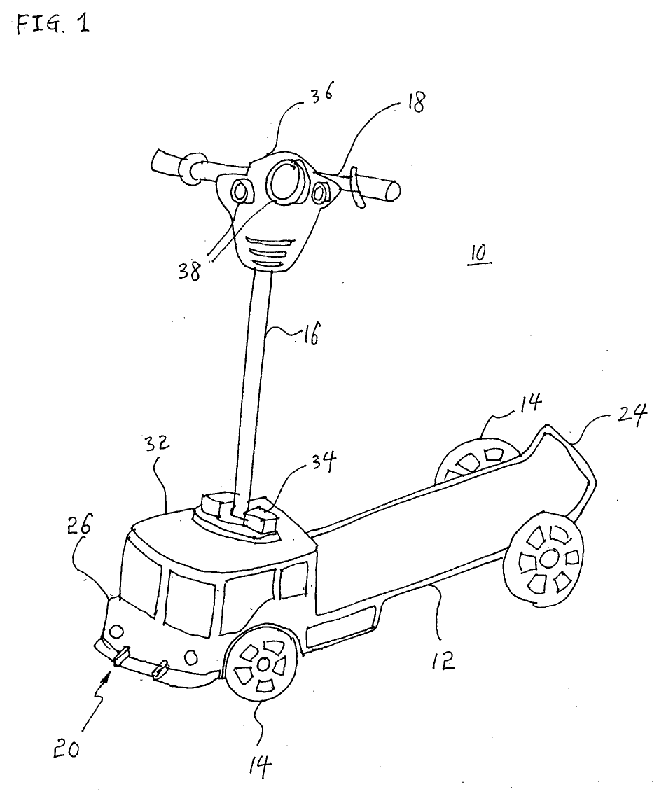

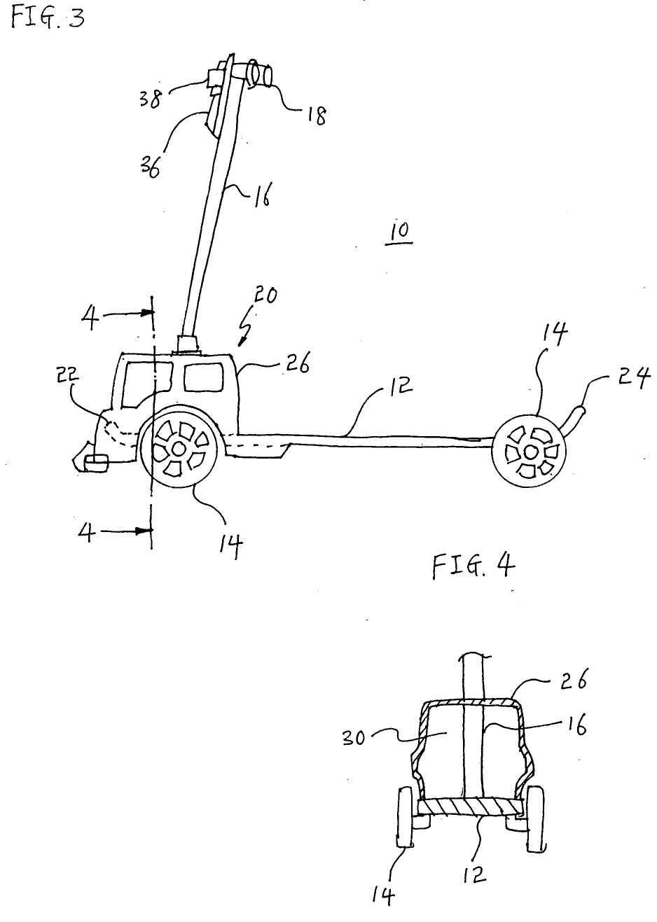

FIGS. 1 and 3 show a scooter 10 according to the present invention. The scooter 10 includes a footboard 12, a plurality of wheels 14 rotatably attached to the footboard 12, an elongated rod 16 attached to the footboard 12, a handle 18 attached to the enlongated rod 16 and a decorative portion 20. The footboard 12 includes a front end 22 and a rear end 24. The elongated rod 16 is attached near or at the front end 22. The elongated rod 16 is substantially perpendicular to the footboard 12.

The decorative portion 20 includes a front decorative portion 26 that is attached near or at the front end 22. The front decorative portion 26 simulates the front portion of a fire engine in FIG. 1. The front decorative portion 26 mocks up the cab, windows, front bumper, fender, and lights of a fire engine. Also, a sticker displaying instrument panels or other tools may be attached to the decorative portion 20.

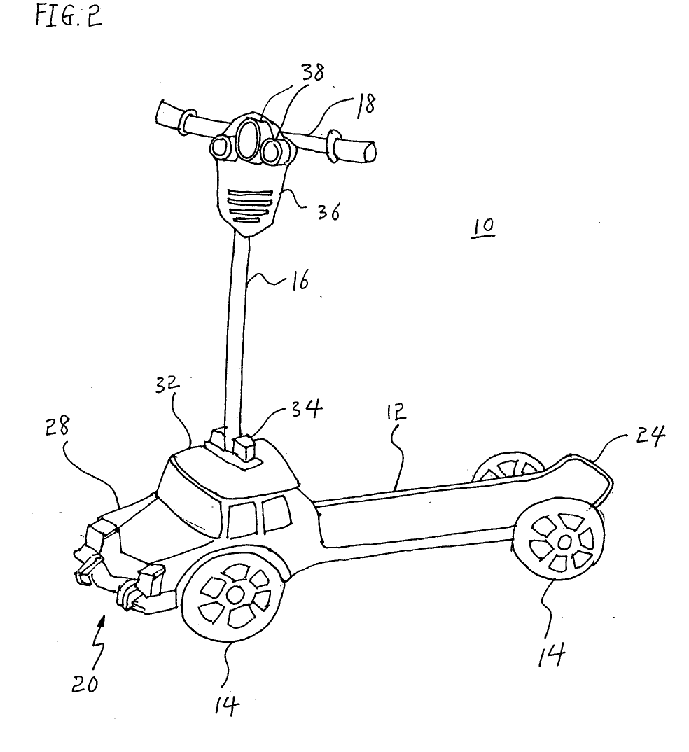

FIG. 2 shows another embodiment of the present invention. The decorative portion includes a front decorative portion 28 that simulates a police car.

FIG. 4 shows that the front decorative portion 26 has a shape of a shell having a front cavity 30. The front cavity 30 substantially encloses the front end 22 of the footboard 12. The front decorative portion 26 is made of flexible material such as plastic.

The front decorative portion 26, 28 simulates a front portion of a vehicle, and the wheels 14 near the front end 22 of the footboard 12 simulate wheels of a vehicle.

Referring back to FIGS. 1 and 2, the front decorative portion 26, 28 simulates a front portion of a fire engine or a police car. The elongated rod 16 passes through the roof 32 of the fire engine or the police car. The roof 32 includes a portion simulating an emergency light 34. The elongated rod 16 passes through the center of the emergency light 34.

The decorative portion 20 further includes a handle decorative portion 36 that is attached to the handle 18. The handle decorative portion 36 includes one or more lamps 38 that simulate lamps of the vehicle. The lamps 38 may be turned on or off by a switch (not shown) provided in the handle 18. In FIG. 2, the handle decorative portion 36 mocks up a front panel of a police motorcycle.

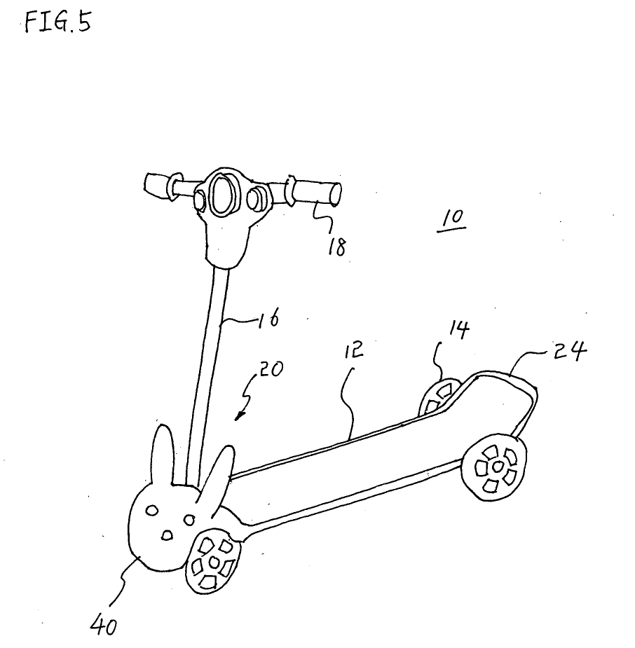

Alternatively, as shown in FIG. 5, the decorative portion 20 includes a front decorative portion 40 that simulates a head and/or body of an animal.

The front decorative portion 26, 28, 40 may be integrated with the footboard 12.

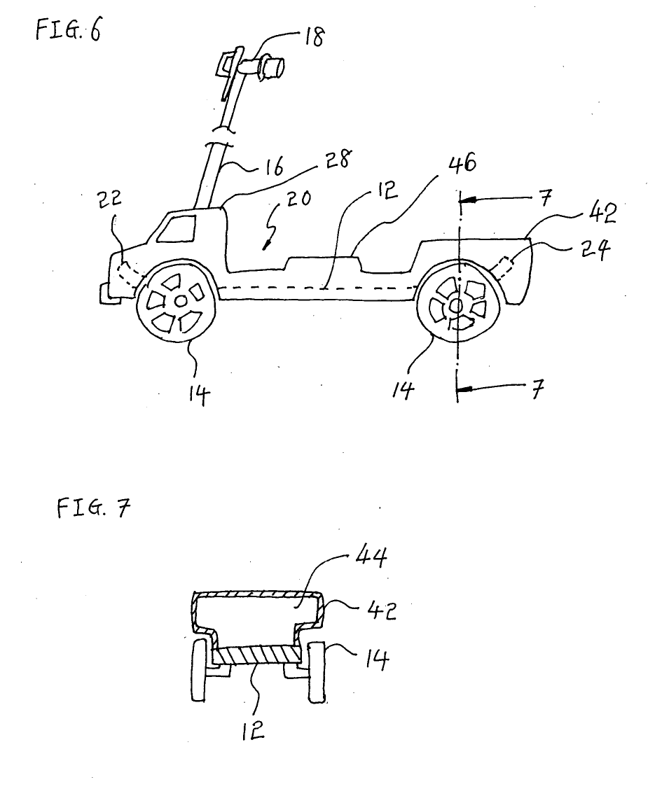

FIG. 6 shows that the decorative portion 20 further includes a rear decorative portion 42 that is attached at the rear end 24 of the footboard 12.

The rear decorative portion 42 may be integrated with the footboard 12.

FIG. 7 shows that the rear decorative portion 42 has a shape of a shell having a rear cavity 44. The rear cavity 44 substantially encloses the rear end 24 of the footboard 12. The rear decorative portion 42 is made of flexible material such as plastic.

The rear decorative portion 42 simulates a rear portion of a vehicle, and the wheels 14 near the rear end 24 of the footboard 12 simulate wheels of a vehicle.

Alternatively, the rear decorative portion simulates a body of an animal.

The decorative portion 20 further includes one or more side decorative portions 46 that are attached to the sides of the footboard,12.

The side decorative portions 46 may be integrated with the footboard 12.

While the invention has been shown and described with reference to different embodiments thereof, it will be appreciated by those skilled in the art that variations in form, detail, compositions and operation may be made without departing from the spirit and scope of the invention as defined by the accompanying claims.

1.-4. (canceled)

5. A scooter comprising:
a) a footboard;
b) a plurality of wheels rotatably attached to the footboard;
c) an elongated rod attached to the footboard;
d) a handle attached to the enlongated rod; and
e) a decorative portion;
wherein the footboard comprises a front end and a rear end, wherein the elongated rod is attached near or at the front end, wherein the decorative portion comprises a front decorative portion that is attached near or at the front end,
wherein the front decorative portion has a shape of a shell having a front cavity, wherein the front cavity substantially encloses the front end of the footboard,
wherein the front decorative portion simulates a front portion of a vehicle,
wherein the front decorative portion simulates a front portion of a fire engine or a police car.

6. The scooter of claim 5, wherein the elongated rod passes through the roof of the fire engine or the police car.

7. The scooter of claim 6, wherein the roof comprises a portion simulating an emergency light.

8. The scooter of claim 5, wherein the decorative portion further comprises a handle decorative portion that is attached to the handle.

9. The scooter of claim 8, wherein the handle decorative portion comprises one or more lamps that simulate lamps of the vehicle.

10. (canceled)

11. (canceled)

12. The scooter of claim 1, wherein the decorative portion further comprises a handle decorative portion that is attached to the handle.

13. The scooter of claim 12, wherein the handle decorative portion comprises one or more lamps that simulate lamps of the vehicle.

14.-20. (canceled)
